(19) United States
(12) Patent Application Publication
(10) Pub. No.: US 2016/0288171 A1
(43) Pub. Date: Oct. 6, 2016

(54) VIBRATORY SHAKER SCREEN ASSEMBLY

(71) Applicant: Continental Wire Cloth, LLC, Jenks, OK (US)

(72) Inventor: James R. Bissett, Broken Arrow, OK (US)

(21) Appl. No.: 14/677,625

(22) Filed: Apr. 2, 2015

(51) Int. Cl. B07B 1/46

(52) U.S. Cl. CPC B07B 1/46

(57) ABSTRACT

A shaker screen comprising a frame and a screen member attached to the frame is provided. The frame has a top surface, a bottom surface, and a sidewall connecting the top surface and bottom surface together. The sidewall has an outside surface and an inside surface. A gasket is attached to the frame, the gasket having a first portion attached to the bottom surface of the frame and a second portion attached to a surface of the sidewall of the frame.

### BACKGROUND

A vibratory shaker machine, sometimes referred to as a shale shaker or mud shaker (hereafter a “shaker machine”), is used in the oil and gas industry and other industries to separate solids from a mixture of solids and liquids. For example, shaker machines are commonly used in processes to reclaim used oil and gas well drilling mud to separate cuttings, rock and other solid particles from the mud.

In operating a shaker machine, the mixture of solids and liquids is caused to flow onto and through a vibratory shaker screen assembly (hereafter a “shaker screen”), which is removably attached to the shaker machine and functions to filters solids from the liquid. In order to facilitate the filtration process and cause the separated solids to slide off the top of the shaker screen, the shaker screen is caused to vibrate by the shaker machine. Usually, two or more shaker screens are positioned side by side on the shaker machine.

A typical shaker screen includes one or more stainless steel mesh screen layers positioned one on top of the other and attached to a perforated metal panel to form a shaker screen subassembly. The shaker screen subassembly is then attached to the top of a metal or steel frame, which holds and supports the subassembly in position within the shaker machine. A gasket is glued to the bottom surface of the frame in order to help create a seal between the frame and the portion of the shaker machine that supports the frame. The sizes of the various openings in the mesh screen layers and the resulting cut point and API classification of the overall shaker screen vary depending on the particular application including the size of the solid particles desired to be separated from the mixture. Each type or model of shaker screen is generally available in a variety of cut points and API classifications.

Due to the strong vibratory forces and harsh environments to which shaker screens are subjected, the shaker screens tend to wear out relatively quickly. As a result, in many applications, the shaker screens mounted to a shaker machine must be replaced every couple of weeks or so.

A component of a shaker screen that tends to fail prematurely is the gasket attached to the bottom surface of the frame. For example, the gasket or portions thereof often detach from the bottom surface of the frame assembly, causing the seal formed thereby to be compromised and/or used gasket material to be imparted to the filtered mixture. Such a failure often occurs well before other components of the shaker screen fail.

### SUMMARY

In accordance with the invention, a shaker screen comprising a frame and a screen member attached to the frame is provided. The frame has a top surface, a bottom surface, and a sidewall connecting the top surface and bottom surface together. The sidewall has an outside surface and an inside surface. A gasket is attached to the frame. In one embodiment, for example, the gasket has a first portion attached to the bottom surface of the frame and a second portion attached to one of the outside surface of the sidewall and the inside surface of the sidewall.

### BRIEF DESCRIPTION OF THE DRAWINGS

FIG. 1 is a perspective view of a typical shaker machine having a plurality of shaker screens mounted therein and attached thereto.

FIG. 2A is a top perspective view of a prior art shaker screen.

FIG. 2B is a bottom perspective view of the prior art shaker screen shown by FIG. 1A.

FIG. 3A is a top perspective view of one embodiment of the inventive shaker screen.

FIG. 3B is a bottom perspective view of the embodiment of the inventive shaker screen shown by FIG. 3A.

FIG. 4A is a cross-sectional view taken along the line 4A-4A of FIG. 3A.

FIG. 4B is a cross-sectional view taken along the line 4B-4B of FIG. 3A.

FIG. 4C is a perspective view of a section of the gasket attached to the frame in the embodiment of the inventive shaker screen shown by FIGS. 3A, 3B, 4A and 4B.

FIG. 5A is a cross-sectional view similar to the cross-sectional view shown by FIG. 4A but illustrating an alternative embodiment of the inventive shaker screen.

FIG. 5B is a cross-sectional view similar to the cross-sectional view shown by FIG. 4B but illustrating the alternative embodiment of the inventive shaker screen shown by FIG. 5A.

FIG. 5C is a perspective view of a section of the gasket attached to the frame in the embodiment of the inventive shaker screen shown by FIGS. 5A and 5B.

FIG. 6A is a cross-sectional view similar to the cross-sectional view shown by FIG. 4A but illustrating yet another alternative embodiment of the inventive shaker screen.

FIG. 6B is a cross-sectional view similar to the cross-sectional view shown by FIG. 4B but illustrating the alternative embodiment of the inventive shaker screen shown by FIG. 6A.

FIG. 6C is a perspective view of a section of the gasket attached to the frame in the embodiment of the inventive shaker screen shown by FIGS. 6A and 6B.

FIG. 7A is an enlarged partial view of the first portion of the gasket that is attached to the bottom surface of the frame of the shaker screen shown by FIGS. 3A, 3B, 4A, 4B, 5A, 5B, 6A and 6B.

FIG. 7B is an enlarged partial view of an alternative embodiment of the first portion of the gasket that can be attached to the bottom surface of the frame of the shaker screen shown by FIGS. 3A, 3B, 4A, 4B, 5A, 5B, 6A and 6B.

FIG. 8A is an enlarged partial view of the gasket that is glued to the bottom surface of the frame of the inventive shaker screen shown by shaker screen shown by FIGS. 3A, 3B, 4A and 4B illustrating a slit therein and a mounting pin inserted through the slit.

FIG. 8B is an enlarged partial view of the gasket shown by FIG. 8A without a mounting pin inserted through the slit.

### DETAILED DESCRIPTION

As used herein and in the appended claims, a shaker machine refers to a vibratory shaker machine. A shaker screen refers to a vibratory shaker screen assembly for use in connection with a shaker machine to separate solids from a mixture of solids and liquids.

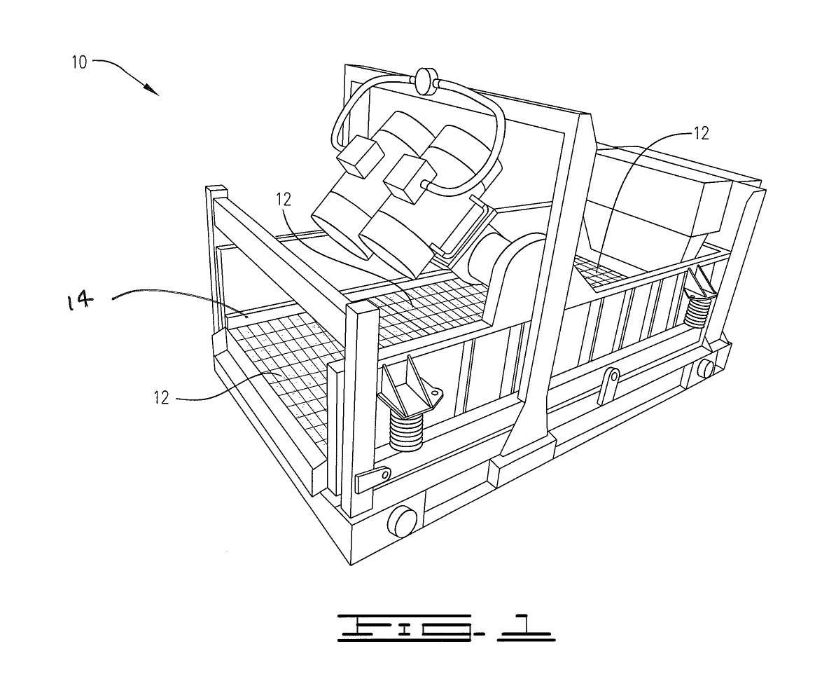

Referring to FIG. 1, a typical shaker machine is described and generally designated by the reference number 10. In this machine, three shaker screens 12, each being identical in shape and size, are attached side by side to the shaker machine 10. The shaker screens 12 are attached to the shaker machine by flanges or wedges 14.

### Prior Art Shaker Screen

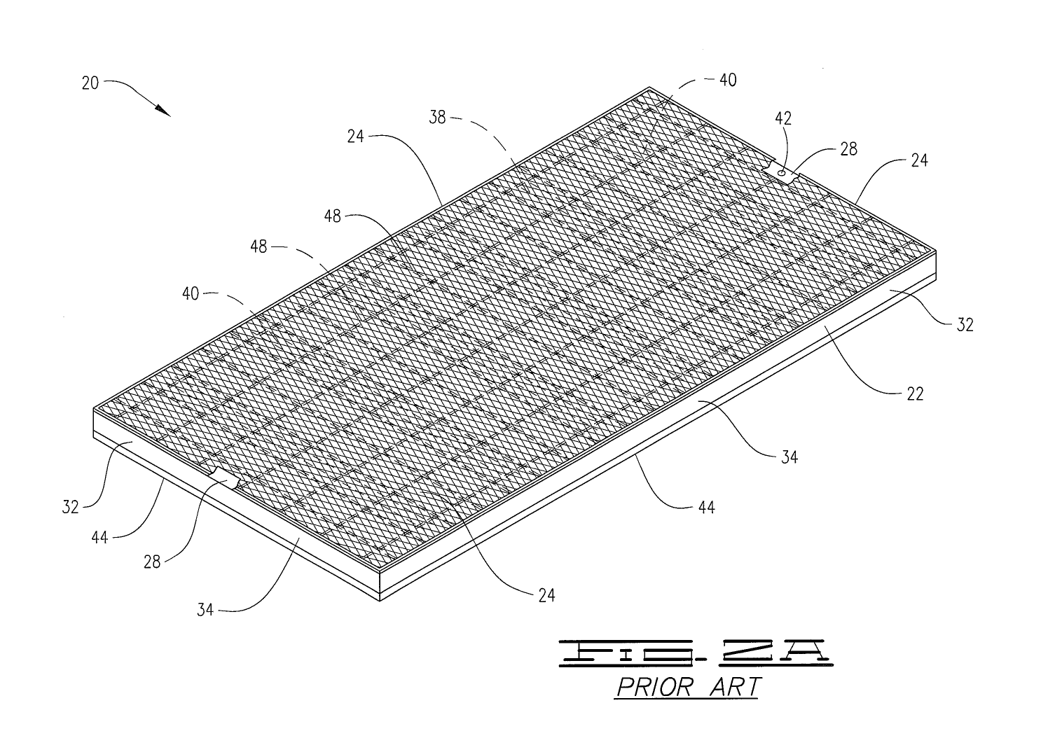

Referring now to FIGS. 2A and 2B, a shaker screen known in the art is described and generally designated by the reference number 20. The shaker screen 20 comprises a frame 22 and a screen subassembly 24 attached to the frame.

The frame 22 includes a top surface 28, a bottom surface 30, and a sidewall 32 connecting the top surface and bottom surface together. The sidewall 32 includes an outside surface 34 and an inside surface 36. A plurality of crossbars 38 are attached to and extend from the inside surface 36 of the sidewall 32 on one side of the frame 22 to the inside surface of the sidewall on the opposite side of the frame. Each crossbar 38 has a top surface 40. The top surfaces 40 of the crossbars 38 are part of the top surface 28 of the frame 22. The frame further includes an open slot 42 extending through the frame for receiving a pin that is attached to a shaker machine.

A gasket 44 is attached to the bottom surface 30 of the frame 22. As shown by FIG. 2B, the gasket 44 extends all the way around the bottom surface 30 of the frame 22. The gasket 44 includes an open slot 46 positioned on top of the open slot 42 of the frame 22 for receiving a pin that is attached to a shaker machine and extends through the open slot 42 of the frame.

The screen subassembly 24 includes one or more mesh screen layers 48 attached to a perforated metal panel 50. The screen subassembly 24 is attached tot the top surface 28 of the frame 22 including the top surfaces 40 of the crossbars 38 of the frame.

As stated above, due to the strong vibratory forces and harsh environments to which shaker screens are subjected, the gasket 44 or one or more portions thereof tend to prematurely detach from the bottom surface 30 of the frame 22, causing the seal formed thereby to be compromised and/or used gasket material to be imparted to the filtered mixture. Such a failure often occurs well before other components of the shaker screen 20 fail.

### Inventive Shaker Screen

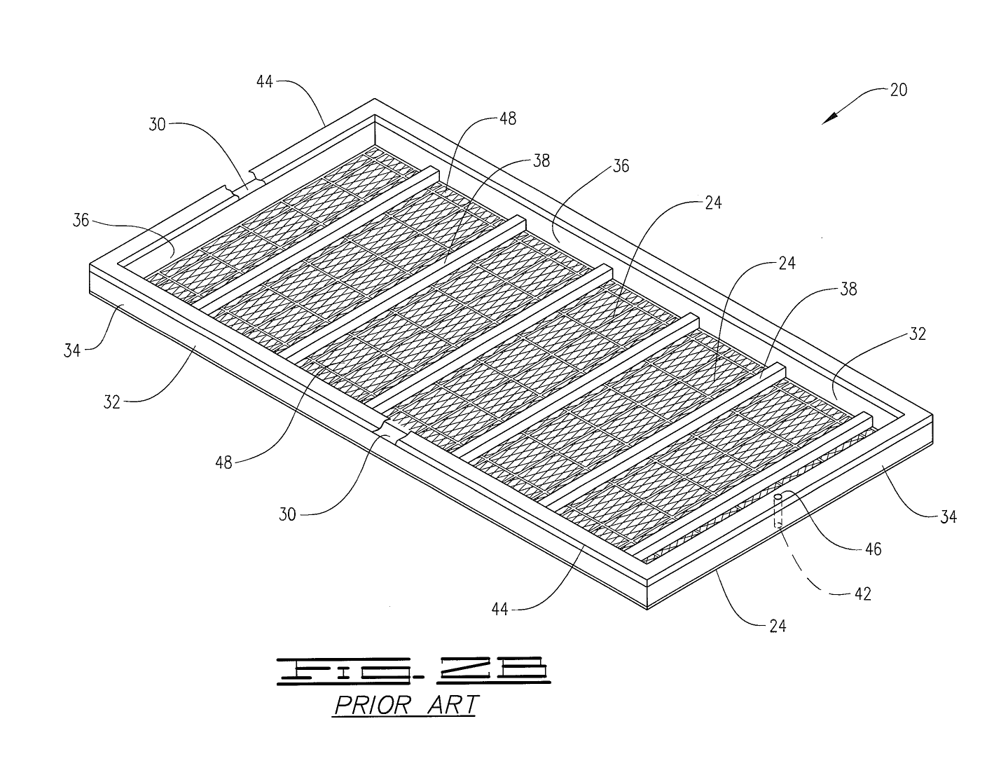

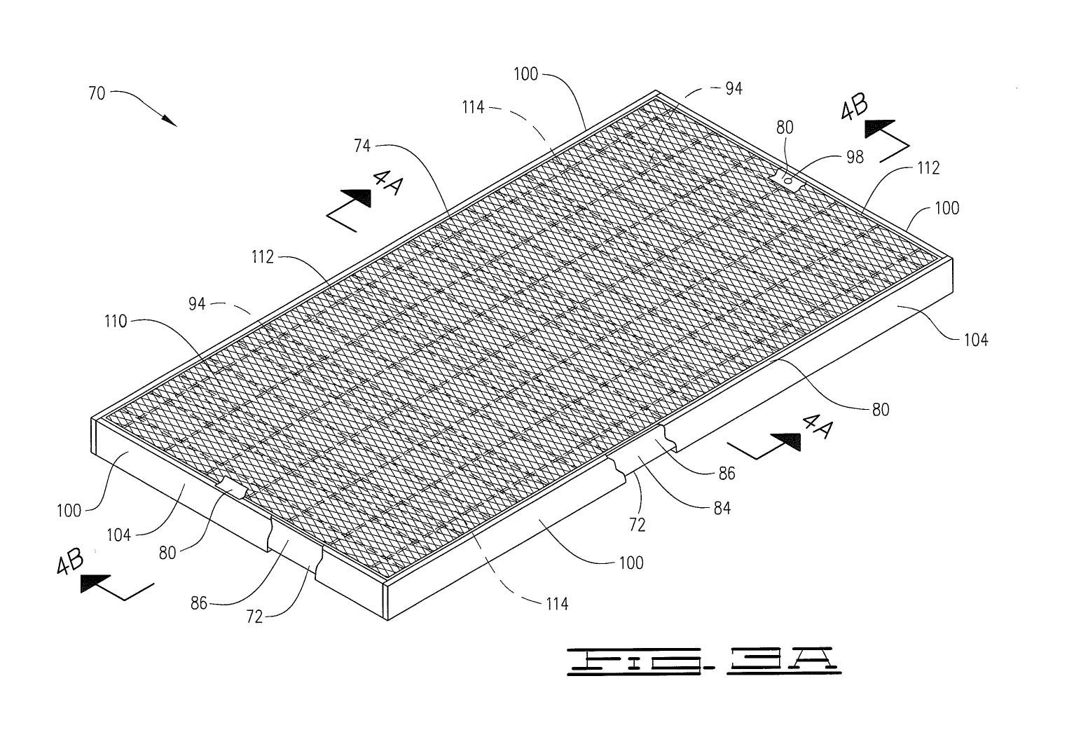

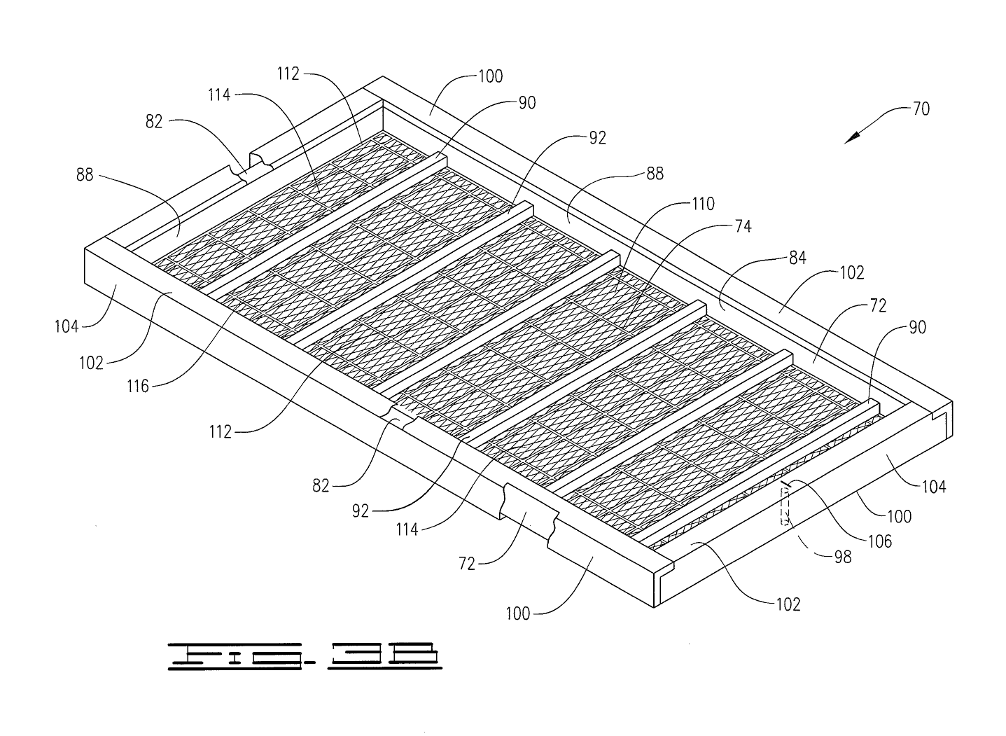

Referring now to FIGS. 3A, 3B, 4A, 4B and 4C, a first embodiment of the inventive shaker screen is described and generally designated by the numeral 70.

The shaker screen 70 comprises a frame 72 and a screen member 74 attached to the frame. The frame 72 supports and holds the screen member 74.

The frame 72 includes a top surface 80, a bottom surface 82, and a sidewall 84 connecting the top surface and bottom surface together. The sidewall 88 includes an outside surface 86 and an inside surface 88. A plurality of crossbars 90 are attached to and extend from the inside surface 88 of the sidewall 84 on one side of the frame 72 to the inside surface 88 of the sidewall 84 on the opposite side of the frame 72. Each crossbar 90 includes a bottom surface 92 and a top surface 94. The top surfaces 94 of the crossbars 90 are part of the top surface 80 of the frame 72. An open slot 98 extends through the frame 72 (for example, the bottom portion 82 of the frame) for receiving a pin that is attached to a shaker machine (for example, the basket of a shaker machine). For example, the frame can be formed of metal or steel.

A gasket 100 is attached (for example, glued) to the frame 72. The gasket 100 includes a first portion 102 attached to the bottom surface 82 of the frame 72 and a second portion 104 attached to the outside surface 86 of the sidewall 84. Alternatively, the second portion 104 can be attached to the inside surface 88 of the sidewall 84. For example, in this embodiment, the first portion 102 of the gasket 100 is attached to the second portion 104 of the gasket. Alternatively, the first portion 102 and second portion 104 of the gasket 100 are not attached together. For example, the gasket 100 extends all the way around the bottom surface 82 of the frame 72 and the outside surface 86 of the sidewall 84 of the frame.

The gasket 100 further includes a self-sealing slit 106 therein positioned over said open slot 98 of said frame 72 for receiving a pin that is attached to a shaker machine (for example, the basket of a shaker machine) and extends through the open slot of the frame. For example, if the open slot 98 is positioned in the bottom surface 82 of the frame 72, the slit 106 is positioned in the first portion 102 of the gasket 100.

In one embodiment, the screen member 74 is a single mesh screen layer 110. In another embodiment, the screen member 74 is a screen subassembly that includes one or more mesh screen layers 110 attached to a panel 112 having a plurality of openings 114 therein. For example, the screen member 74 is attached to the top surface 80 of the frame 72 including the top surfaces 94 of the crossbars 90. The screen member 74 can be attached to the frame 72 by a variety of different attachment methods including attachment by rivets and attachment by glue or epoxy.

When more than one mesh screen layers 110 is utilized, the mesh screen layers are positioned one on top of the other and attached to the panel 112. For example, the mesh screen layer(s) 110 can be formed of stainless steel. For example, the panel 112 can be formed of metal. For example, the openings 114 of the panel 112 can each have a square or rectangular shape.

Each mesh screen layer 110 has a plurality of openings 116 therein. The sizes of the openings 116 and the resulting cut point and API classification of the overall shaker screen 70 can vary depending on the particular application including the size of the solid particles desired to be separated from the mixture.

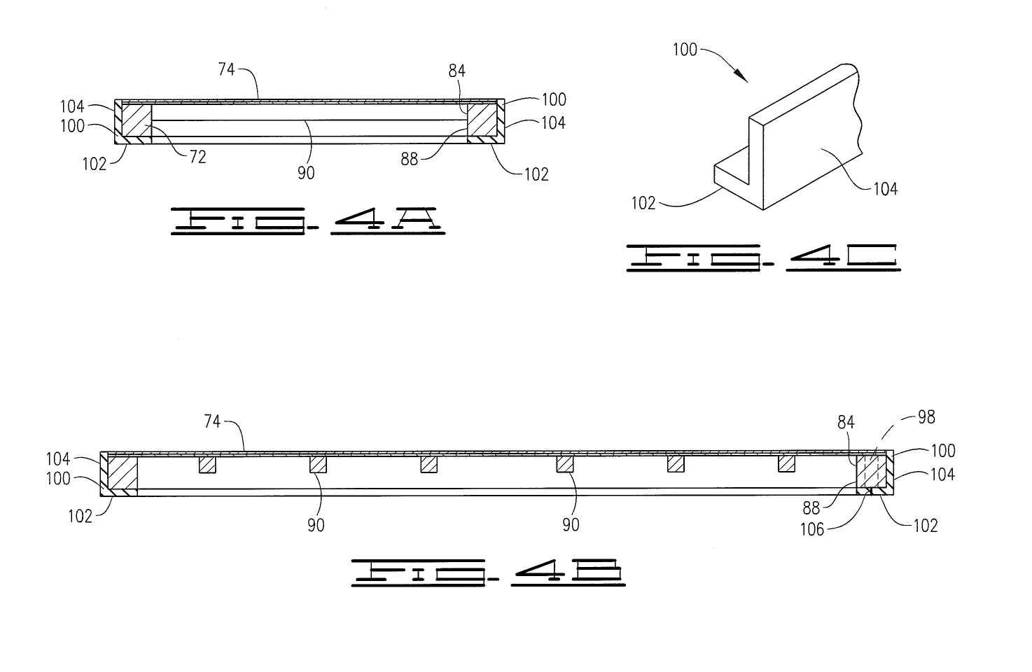

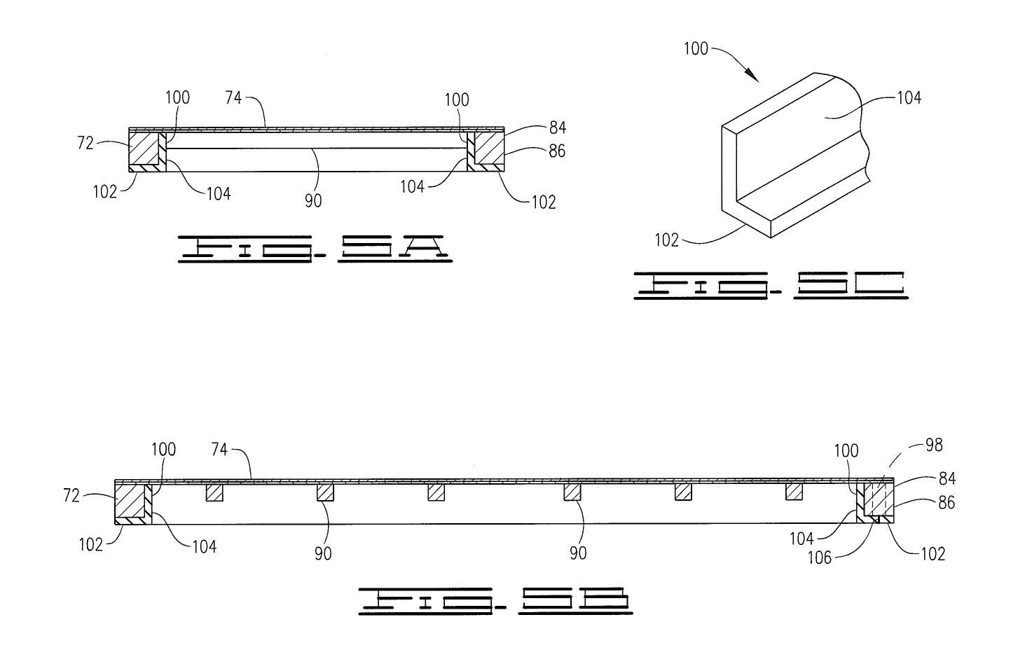

As shown by FIGS. 5A and 5B, in an alternative embodiment of the inventive shaker screen 70, the second portion 104 of the gasket 100 is attached to the inside surface 88 of the sidewall 84 as opposed to the outside surface 86 of the sidewall. For example, in this embodiment, the first portion 102 of the gasket 100 is attached to the second portion 104 of the gasket. Alternatively, the first portion 102 and second portion 104 of the gasket are not attached together. For example, in this embodiment, the gasket 100 extends all the way around the bottom surface 82 of the frame 72 and the inside surface 88 of the sidewall 84 of the frame.

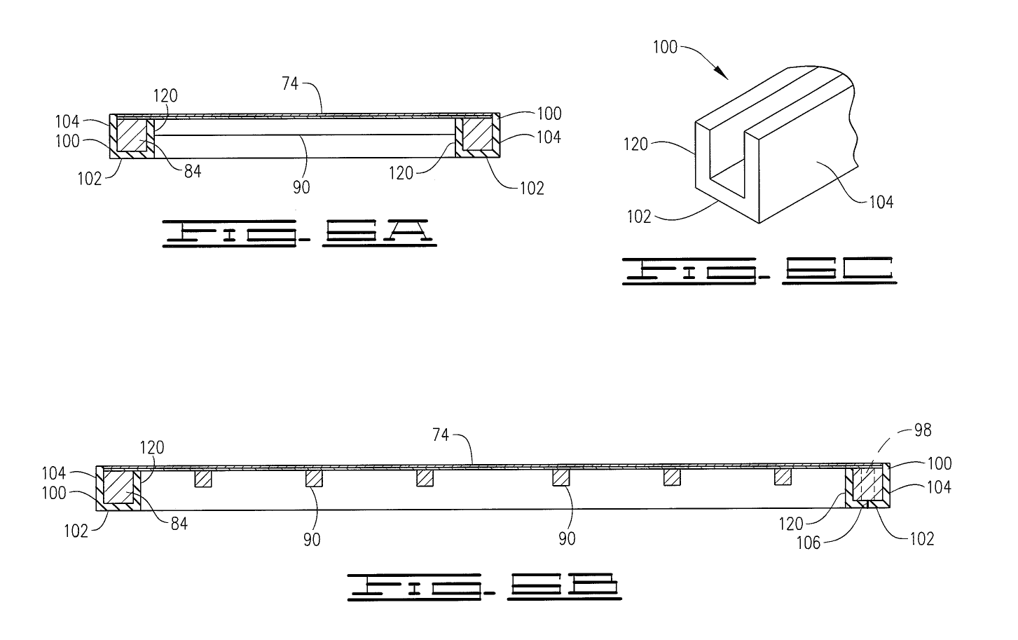

As shown by FIGS. 6A and 6B, in yet another embodiment of the inventive shaker screen 70, the second portion 104 of the gasket 100 is attached to the outside surface 86 of the sidewall 84, and the gasket 100 further includes a third portion 120 attached to the inside surface 88 of the sidewall 84 if the frame 72. For example, in this embodiment, the first portion 102 of the gasket 100 is attached to both second portion 104 and the third portion 120 of the gasket 100. Alternatively, the first portion 102, second portion 104 and third portion 120 of the gasket 100 are not attached together or only the first and second portion or second and third portions of the gasket are attached together. For example, in this embodiment, the gasket 100 extends all the way around the bottom surface 82 of the frame 72 and both the outside surface 86 and the inside surface 88 of the sidewall 84 of the frame.

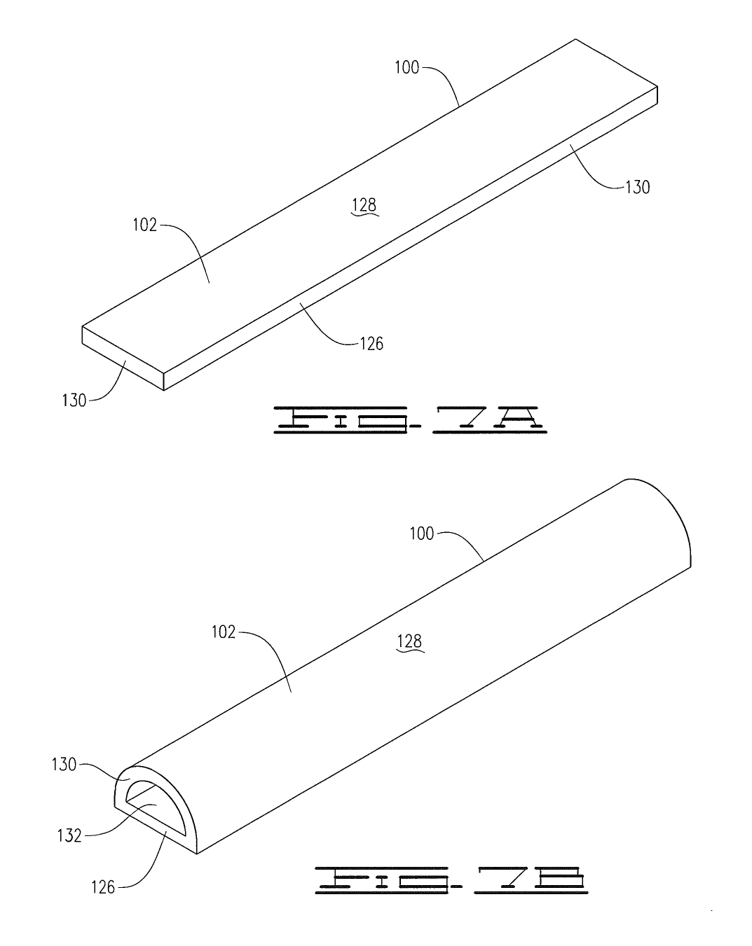

As best shown by FIG. 7A, the first portion 102 of the gasket 100 of the inventive shaker screen 70 includes a flat base section 126 attached to the bottom surface 82 of the frame 72 and a top section 128 separated from the base section by a sidewall 130. The top section 128 of the gasket 100 is flat. The gasket 100 has an elongated shape.

As shown by FIG. 7B, in another embodiment, the top section 128 of the gasket 100 is arched and protrudes outwardly from the base section 126 of the gasket. In this embodiment, the gasket 100 includes a longitudinal opening 132 therein between the base section 126 and the top section 128 of the gasket. The gasket can be formed in other shapes and configurations as well.

The fact that the gasket 100 includes a second portion attached (for example, glued) to another surface of the frame 72 increases the surface area of attachment and causes the gasket to be more strongly and securely bonded to the frame. This helps prevent the gasket 100 from prematurely detaching from the frame 72 during use of the inventive shaker screen 70 in a shaker machine. The fact that the gasket can also include a third portion 120 attached (for example, glued) to yet another surface of the frame 74 (as in the embodiment shown by FIGS. 6A and 6B) even further increases the surface area of attachment and causes the gasket to be more strongly and securely bonded to the frame. Thus, by the invention, the useful life of the shaker screen 70 can be significantly longer than the useful life of shaker screens used heretofore.

The gasket 100 of the shaker screen 70 can be formed of any flexible material that can stand up to the vibratory forces and conditions associated with use of the shaker screen 70. For example, the gasket 100 can be formed of nitrile rubber. For example, the glue used to attach the gasket 100 to the frame 72 (if gluing is used as the attachment method) can be any glue suitable for the materials involved and that can stand up to the vibratory forces and conditions associated with use of the shaker screen 70. For example, the glue can be cyanoacrylate.

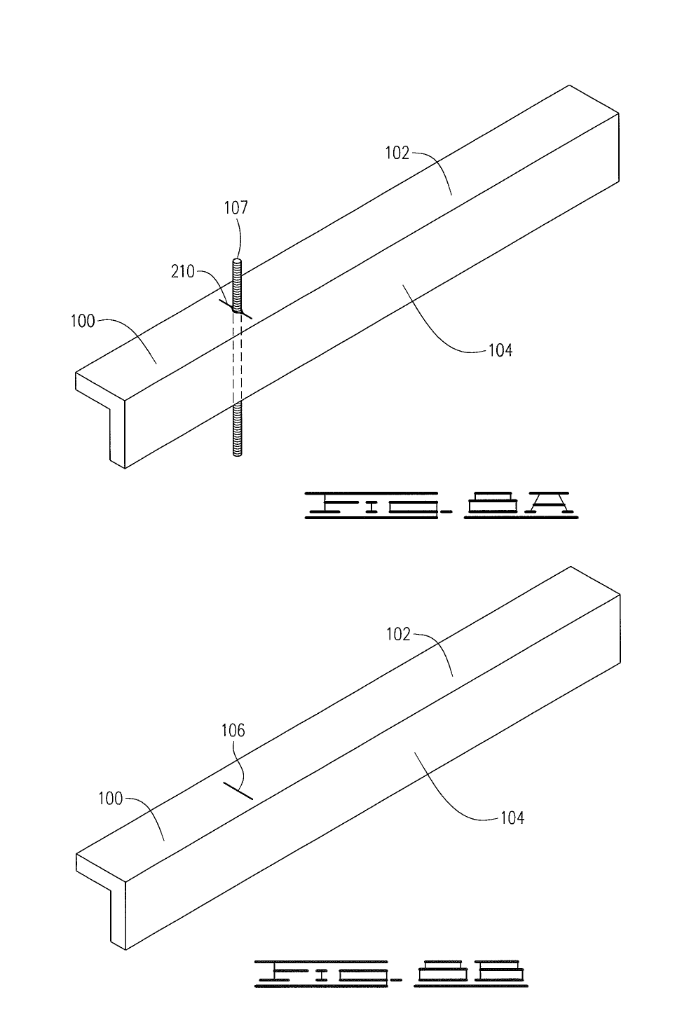

Referring to FIGS. 8A and 8B, the slit 106 is formed in the gasket 100 in a manner that causes it to be self-sealing and allows for the insertion of a pin 136 in or through the gasket. As used herein and in the appended claims, a self-sealing slit is a slit having inside surfaces that tend to bias toward and into contact with one another when a pin is not inserted in the slit or tend to bias toward and into contact with the pin when a pin that is inserted in or through the slit.

The biasing function of the slit helps prevent liquid from entering and going through the slit when the shaker screen 70 is in use. For example, the inner surfaces of the slit 106 tend to seal around the pin 136 when the pin is inserted in the slit. When the pin 136 is not inserted in the slit 106, the slit 116 returns to a narrow, closed or substantially closed position.

The general shape (for example, rectangular, square, round), thickness and size of the shaker screen 70 can vary depending on the type of shaker machine in connection with which the shaker screen is to be used. The shaker screen 70 can be formed to have any cut point, API classification and other characteristic, feature or property necessary or desirable for the application in which the shaker screen is used.

Thus, for example, in one embodiment, the inventive shaker screen comprises a frame and a screen member attached to the frame. The frame has a top surface, a bottom surface, and a sidewall connecting the top surface and bottom surface together. The sidewall has an outside surface and an inside surface. A gasket is attached to the frame. The gasket has a first portion attached to the bottom surface of the frame and a second portion attached to one of the outside surface of the sidewall and the inside surface of the sidewall.

In another embodiment, for example, the inventive shaker screen comprises a frame and a screen member attached to the frame. The frame has a top surface, a bottom surface, and a sidewall connecting the top surface and bottom surface together. The sidewall has an outside surface and an inside surface. A gasket is attached to the frame. The gasket has a first portion attached to the bottom surface of the frame, a second portion attached to the outside surface of the sidewall of the frame, and a third portion attached to the inside surface of the sidewall of the frame.

In yet another embodiment, for example, the inventive shaker screen comprises a frame and a screen member attached to the frame. The frame has a top surface, a bottom surface, a sidewall connecting the top surface and bottom surface together, and an open slot extending through the frame for receiving a pin that is attached to a shaker machine. The sidewall has an outside surface and an inside surface. A gasket is attached to the frame. The gasket has a first portion attached to the bottom surface of the frame. The gasket further includes a self-sealing slit positioned over said open slot of the frame for receiving the pin.

In use, one or more of the shaker screens 70 are inserted and attached to a shaker machine such as the shaker machine 10 shown by FIG. 1. The first portion 102 of the gasket 100 of the shaker screen 70 helps create a seal between the bottom surface 82 of the frame 72 and the portion of the shaker machine that supports the frame. When attached to the outside surface 86 of the sidewall 84 of the frame 72, the second portion 104 of the gasket 100 helps create a seal between the sidewall of the frame and the shaker machine and/or between the sidewalls of shaker screens 70 that are mounted adjacent to one another in the machine.

As the shaker screen 70 is vibrated by the shaker machine, the mixture of solids and liquids (for example, used drilling mud) is caused to flow onto and through the screen member 74 which functions to filters solids from the liquid. The vibration of the shaker screen facilitates the filtration process and causes the separated solids to slide off the top of the shaker screen.

What is claimed is:

1. A shaker screen, comprising:
a frame, said frame having a top surface, a bottom surface, and a sidewall connecting said top surface and said bottom surface together, said sidewall having an outside surface and an inside surface;
a gasket having a first portion attached to said bottom surface of said frame and a second portion attached to one of said outside surface of said sidewall and said inside surface of said sidewall; and
a screen member attached to said frame.

2. The shaker screen of claim 1, wherein said screen member is attached to said top surface of said frame.

3. The shaker screen of claim 1, wherein said screen member is a screen subassembly that includes one or more mesh layers attached to a panel having a plurality of openings therein.

4. The shaker screen of claim 1, wherein said second portion of said gasket is attached to said outside surface of said sidewall.

5. The shaker screen of claim 1, wherein said second portion of said gasket is attached to said inside surface of said sidewall.

6. The shaker screen of claim 1, wherein said first portion of said gasket and said second portion of said gasket are attached together.

7. The shaker screen of claim 4, wherein said gasket further includes a third portion attached to said inside surface of said sidewall.

8. The shaker screen of claim 7, wherein said first portion of said gasket is connected to both said second portion of said gasket and said third portion of said gasket.

9. The shaker screen of claim 1, wherein said frame further includes an open slot extending through said frame for receiving a pin that is attached to a shaker machine, and said gasket further includes a self-sealing slit positioned over said open slot of said frame for receiving said pin.

10. The shaker screen of claim 9, wherein said open slot of said frame extends through said bottom surface of said frame, and said slit of said gasket is positioned in said first portion of said gasket.

11. A shaker screen, comprising:
a frame, said frame having a top surface, a bottom surface, and a sidewall connecting said top surface and said bottom surface together, said sidewall having an outside surface and an inside surface;
a gasket having a first portion attached to said bottom surface of said frame, a second portion attached to said outside surface of said sidewall, and a third portion attached to said inside surface of said sidewall; and
a screen member attached to said frame.

12. The shaker screen of claim 11, wherein said screen member is attached to said top surface of said frame.

13. The shaker screen of claim 11, wherein said screen member is a screen subassembly that includes one or more mesh layers attached to a panel having a plurality of openings therein.

14. The shaker screen of claim 11, wherein said first portion of said gasket is connected to both said second portion of said gasket and said third portion of said gasket.

15. The shaker screen of claim 11, wherein said frame further includes an open slot extending through said frame for receiving a pin that is attached to a shaker machine, and said gasket further includes a self-sealing slit positioned over said open slot of said frame for receiving said pin.

16. The shaker screen of claim 5, wherein said open slot of said frame extends through said bottom surface of said frame, and said slit of said gasket is positioned in said first portion of said gasket.

17. A shaker screen, comprising:
a frame, said frame having a top surface, a bottom surface, a sidewall connecting said top surface and bottom surface together, and an open slot extending through said frame for receiving a pin that is attached to a shaker machine, said sidewall of said frame having an outside surface and an inside surface;
a gasket having a first portion attached to said bottom surface of said frame, said gasket including a self-sealing slit positioned over said open slot of said frame for receiving said pin; and
a screen member attached to said frame.

18. The shaker screen of claim 16, wherein said gasket further includes a second portion attached to one of said outside surface of said sidewall and said inside surface of said sidewall.

19. The shaker screen of claim 18, wherein said second portion of said gasket is attached to said outside surface of said sidewall.

20. The shaker screen of claim 19, wherein said gasket further includes a third portion attached to said inside surface of said sidewall.
